(19) United States
(12) Patent Application Publication
(10) Pub. No.: US 2012/0003891 A1
(43) Pub. Date: Jan. 5, 2012

(54) PREPREGS AND MOLDED BODIES PRODUCED FROM SAME

(75) Inventors: Friedrich Georg Schmidt, Haltern am See (DE); Emmanouil Spyrou, Schermbeck (DE); Werner Grenda, Herne (DE); Sebastian De Nardo, Gelsenkirchen (DE); Sibylle Planitz-Penno, Schwerte (DE)

(73) Assignee: EVONIK DEGUSSA GmbH, Essen (DE)

(21) Appl. No.: 13/256,394

(22) PCT Filed: Jan. 13, 2010
(86) PCT No.: PCT/EP2010/050319

§ 371 Date: Sep. 13, 2011

(30) Foreign Application Priority Data
Mar. 24, 2009 (DE) 102009001793.3

(51) Int. Cl. B32B 5/02; B05D 3/00; B05D 7/00

(52) U.S. Cl. 442/59; 427/180

(57) ABSTRACT

The invention relates to prepregs and composite components produced therefrom (mouldings), obtainable by the use of powdery reactive polyurethane compositions.

The invention relates to prepregs and composite components produced therefrom (mouldings), obtainable by the use of powdery reactive polyurethane compositions.

Various moulding processes, such as for example the reaction transfer moulding (RTM) process, comprise the introduction of the reinforcing fibres into a mould, the closing of the mould, the introduction of the crosslinkable resin formulation into the mould and the subsequent crosslinking of the resin, typically by application of heat.

One of the limitations of such a process is relative difficulty of laying the reinforcing fibres in the mould. The individual layers of the fabric or non-woven must be cut to size and adapted to a great variety of mould geometries. This can be both time-intensive and also complicated, in particular when the moulding is also intended to contain foam or other cores. Mouldable fibre reinforcements with simple handling and pre-existing reshaping possibilities would be desirable here.

Fibre reinforced materials in the form of prepregs are already used in many industrial applications because of their ease of handling and the increased efficiency during processing in comparison to the alternative wet lay-up technology.

Industrial users of such systems, as well as faster cycle times and higher storage stabilities even at room temperature, also demand the possibility of cutting the prepregs to size, without the cutting tools becoming contaminated with the often sticky matrix material during automated cutting to size and lay-up of the individual prepreg layers.

As well as polyesters, vinyl esters and epoxy systems, there are a range of specialized resins in the field of the crosslinking matrix systems. These also include polyurethane resins, which because of their toughness, damage tolerance and strength are used in particular for the production of composite profiles by pultrusion processes. The toxicity of the isocyanates used is often mentioned as a disadvantage.

Polyurethane composites also exhibit superior toughness compared to vinyl esters, unsaturated polyester resins (UPR) or UPR-urethane hybrid resins.

Prepregs and composites produced therefrom on the basis of epoxy systems are for example described in WO 98/50211, U.S. Pat. No. 4,992,228, U.S. Pat. No. 5,080,857, U.S. Pat. No. 5,427,725, GB 2007676, GB 2182074, EP 309 221, EP 297 674, WO 89/04335, U.S. Pat. No. 5,532,296 and U.S. Pat. No. 4,377,657, U.S. Pat. No. 4,757,120.

In WO 2006/043019, a process for the production of prepregs on the basis of epoxy resin polyurethane powders is described.

Furthermore, prepregs based on thermoplastics in powder form as the matrix are known.

In US 2004/0231598, a method is described wherein the particles are passed through a special acceleration chamber with electrostatic charging. This device is used for the coating of glass, aramid or carbon fibre substrates for the production of prepregs from thermoplastic resins. As resins, polyethylene (PE), polypropylene (PP), polyether ether ketone (PEEK), polyether sulphone (PES), polyphenyl sulphone (PPS), polyimide (PI), polyamide (PA), polycarbonate (PC), polyethylene terephthalate (PET), polyurethane (PU), polyester and fluoro polymers are mentioned. The thermoplastic prepreg textiles produced therefrom exhibit inherent toughness, good viscoelastic damping behaviour, unlimited storage life, and good chemicals resistance and recyclability.

In WO 98/31535, a method for powder impregnation is described, wherein the glass or carbon fibre strands to be impregnated are impacted with a particle/liquid or particle/gas mixture in a defined velocity profile. In this, the powders consist of ceramic or thermoplastic materials, inter alia thermoplastic polyurethane.

In WO 99/64216, prepregs and composites and a method for the production thereof are described, wherein emulsions with polymer particles so small that individual fibre coating is enabled are used. The polymers of the particles have a viscosity of at least 5000 centipoises and are either thermoplastics or crosslinking polyurethane polymers.

In EP 0590702, powder impregnations for the production of prepregs are described, wherein the powder consists of a mixture of a thermoplastic and a reactive monomer or prepolymers.

WO 2005/091715 likewise describes the use of thermoplastics for the production of prepregs.

Michaeli et al. describe the development of a powder technology for a pultrusion process with thermoplastic polyurethanes, referred to as TPU, in Coatings & Composite Materials, No. 19, p 37-39, 1997.

Further, in the article Processing and properties of thermoplastic polyurethane prepreg. (Ma, C. C. M.; Chiang, C. L. Annual Technical Conference—Society of Plastics Engineers (1991), 49th 2065-9.) thermoplastic polyurethane (TPU) prepregs based on TPU systems containing solvents and water are disclosed.

Prepregs with a matrix based on 2-component polyurethanes (2-C PUR) are known.

The category of the 2-C PUR essentially comprises the standard reactive polyurethane resin systems. In principle, this is a system made up of two separate components. While the critical ingredient of one component is always a polyisocyanate, in the case of the second this is polyols, or with recent developments also amino- or amine-polyol mixtures. The two parts are only mixed together shortly before processing. Thereafter the chemical curing takes place by polyaddition with formation of a network of polyurethane or polyurea.

After mixing of the two components, 2-component systems have a limited processing time (stand time, pot life), as the reaction that sets in leads to a gradual viscosity increase and finally to gelling of the system. However, many factors determine the effective duration of its processability: reactivity of the reaction partners, catalysis, concentration, solubility, moisture content, NCO/OH ratio and ambient temperature are the most important [Lackharze, Stoye/Freitag, Hauser-Verlag 1996, pages 210/212].

The disadvantage of the prepregs based on such 2-C PUR systems is that only a short time is available for the processing of the prepreg into a composite. Consequently such prepregs are not stable over several hours, let alone days.

Below there follows a description of the polyurethane prepregs or composites based on 2-C PUR systems.

In the article by K. Recker, the development of a 2-C polyurethane system for the resin mat process with particular reference to the processing properties for SMC components is reported. (Baypreg—a novel POLYURETHANE material for the resin mat process, Recker, Klaus, Kunststoffe-Plastics 8, 1981).

WO 2005/049301 discloses a catalytically activated 2-C PUR system, wherein the polyisocyanate component and the polyol are mixed and processed into a composite by pultrusion.

In WO 2005/106155, fibre reinforced composites for the construction industry are disclosed, which are produced by the long fibre injection (LFI) technology with 2-C polyurethane systems.

In JP 2004196851, composites are described which are produced from carbon fibres and organic fibres, such as for example hemp, with the use of a matrix of 2-C PUR based on polymeric methylenediphenyl diisocyanate (MDI) and specific OH group-containing compounds.

EP 1 319 503 describes polyurethane composites wherein special polyurethane covering layers for a fibre laminate impregnated with a 2-C PUR resin, which coats a core layer (e.g. a paper honeycomb) are used. The 2-C PUR resin for example consists of MDI and a mixture of polypropylene triols and diols from ethylene oxide propylene oxide copolymers. In WO 2003/101719, polyurethane-based composites and the methods of production are described. These are 2-C polyurethane resins with defined viscosities and specific gel times.

2-C PUR systems are also discussed in: “Fiber reinforced polyurethane composites: shock tolerant components with particular emphasis on armor plating” (Ratcliffe, Colin P.; Crane, Roger M.; Santiago, Armando L., AMD (1995), 211 (Innovative Processing and Characterization of Composite Materials), 29-37.) and in Fiber-reinforced polyurethane composites. I. Process feasibility and morphology. (Ma, Chen Chi M.; Chen, Chin Hsing. International SAMPE Symposium and Exhibition (1992), 37 (Mater. Work. You 21st Century), 1062-74.)

Apart from the different binder basis, moisture-curing lacquers largely correspond to analogous 2-C systems both in their composition and also in their properties. In principle, the same solvents, pigments, fillers and auxiliary substances are used. Unlike 2-C lacquers, for stability reasons these systems tolerate no moisture whatsoever before their application.

Also known are physically drying systems based on non-reactive PUR elastomers. These are high molecular weight, linear, thermoplastic urethanes from diols and diisocyanates, preferably MDI, TDI, HDI and IPDI. Such thermoplastic systems as a rule exhibit very high viscosities and hence also very high processing temperatures. This critically hinders their use for prepregs.

In the production of prepregs with fibre composites, the use of powders in reactive systems is more unusual and until now has been limited to a few use fields. Probably the most common process for applying a powder onto a fibre surface is the fluidized bed process (fluidized bed impregnation). By means of an upwardly directed flow, powder particles are converted to a state wherein they exhibit fluid-like properties. This process is used in EP 590 702. In this, the strands of individual fibre bundles are floated apart and coated with the powder in the fluidized bed. The powder here consists of a mixture of reactive and thermoplastic powder, in order thus to optimize the properties of the matrix. Finally, individual rovings (fibre bundles) are laid together and several layers compressed under a pressure of 16 bar for about 20 minutes. The temperatures vary between 250 and 350° C. However, in the fluidized bed process irregular coating often occurs, in particular if the strands are not pulled apart. Concerning this, in US 20040231598 a method is proposed which functions similarly to the fluidized bed process. In this, an air flow transports the particles to the substrate and a uniform deposition of the powder is effected through a specific configuration.

A further process is described in US 20050215148. There uniform distributions of the powder on the fibres are achieved with the device just mentioned. In this, the particle size ranges from 1 to 2000 μm. In several experiments, coating is effected from one or from two sides. Through the uniform application of the powder, laminates with no air inclusions are obtained after subsequent compression of the prepreg.

A further application, WO 2006/043019, describes the use of epoxy and amino-terminated resins in powder form. In this, the powders are mixed and applied onto the fibres. Next, the particles are sintered on. The particle size lies between 1 and 3000 μm, but preferably between 1 and 150 μm.

This restriction of the particle size to rather small diameters is also recommended in a study by the Michigan State University. The theory here is that particles with small diameters will more likely be able to penetrate into cavities between individual filaments than particles with larger diameters (S. Padaki, L. T. Drzal: a simulation study on the effects of particle size on the consolidation of polymer powder impregnated tapes, Department of Chemical Engineering, Michigan State University, Composites: Part A (1999), pp. 325-337).

Apart from the prepreg technology, reactive powder systems are also used in other standard processes, for example in winding technology [M. N. Ghasemi Nejhad, K. M. Ikeda: Design, manufacture and characterization of composites using on-line recycled thermoplastic powder impregnation of fibres and in-situ filament winding, Department of Mechanical Engineering, University of Hawaii at Manoa, Journal of Thermoplastic Composite Materials, Vol 11, pp. 533-572, November 1998] or in the pultrusion process. For the pultrusion process for example fibre strands (towpregs) are coated with the powder and firstly wound and stored as so-called towpregs. One possibility for their production is described in an article in the SAMPE Journal [R. E. Allred, S. P. Wesson, D. A. Babow: powder impregnation studies for high temperature towpregs, Adherent Technologies, SAMPE Journal, Vol. 40, No. 6, pp. 40-48, November/December 2004]. In a further study, such towpregs were pressed together by the pultrusion process and cured to give material components [N. C. Parasnis, K. Ramani, H. M. Borgaonkar: Ribbonizing of electrostatic powder spray impregnated thermoplastic tows by pultrusion, School of Mechanical Engineering, Purdue University, Composites, Part A, Applied science and manufacturing, Vol. 27, pp. 567-574, 1996]. Although the production of towpregs and subsequent compression in the pultrusion process had already been performed with duroplastic systems, to a large extent only thermoplastic systems have until now been used in this process.

The objective was to find a polyurethane-based prepreg system which can be handled without difficulty, i.e. is non-toxic, and which does not have the high viscosities of thermoplastic polyurethane systems with the attendant difficulty in fibre saturation or fabric saturation, and does not have the short processing times of 2C polyurethane systems. A further objective of this invention was therefore to find prepregs with polyurethane matrix material which can be produced by a simple process, wherein the main emphasis should be placed on the handling and storage life of the prepregs.

For the prepregs according to the invention it is advantageous if the viscosity of the noncrosslinked matrix materials is low enough to ensure wetting of the fibrous support during the production of the composite component, during which thixotropy can also be advantageous, so that run-off of the resin in vertical component segments can be prevented. Through the choice of suitable starting materials for production of the matrix materials, a sufficiently long processing time (depending on the particular application in the production of the composites) between the melting of the not completely reacted matrix material and the completion of the reaction can be ensured.

Surprisingly, it has now been found that polyurethane-based prepregs which are storage-stable, but still reactive and thus crosslinkable during the composite component production, may be produced with polyurethane compositions which prepregs can be used for the production of high performance composites for various applications in the sector of the construction, automobile, aerospace industry, energy technology (wind power plants) and in boat and ship-building. The reactive powdery polyurethane compositions present according to the invention are environmentally harmless, low cost, exhibit good mechanical properties, are easy to process and after curing are characterized by good weather resistance and a balanced relationship between rigidity and flexibility.

The subject matter of the invention is prepregs, essentially made up of

A) at least one fibrous support and
B) at least one reactive powdery polyurethane composition as matrix material.

The prepregs produced according to the invention exhibit very high storage stability at room temperature, provided that the matrix material has a Tg of at least 40° C. Depending on the reactive powdery polyurethane composition contained, this is at least several days at room temperature, but as a rule the prepregs are storage-stable for several weeks at 40° C. and below.

After applying and fixing, preferably by heat treatment, preferably by incipient sintering of the reactive powdery polyurethane composition but without crosslinking, the prepregs are not sticky and are thus very easy to handle and to process further. Hence the reactive powdery polyurethane compositions used according to the invention exhibit very good adhesion and distribution on the fibrous support.

During the further processing of the prepregs to composites (composite materials) e.g. by compression at elevated temperatures, very good impregnation of the fibrous support takes place owing to the fact that the then liquid low viscosity reactive polyurethane compositions wet the fibres of the support very well before the crosslinking reaction, before a gelling occurs or the complete polyurethane matrix cures throughout due to the crosslinking reaction of the reactive polyurethane composition at elevated temperatures.

Depending on the composition of the reactive powdery polyurethane composition used and catalysts that may have been added, both the rate of the crosslinking reaction in the production of the composite components and also the properties of the matrix can be varied over wide ranges.

In the context of the invention, matrix material is defined as the reactive powdery polyurethane composition used for producing the prepregs and, in the description of the prepregs, the polyurethane composition which is still reactive and which has been fixed on or, respectively, adheres on the fibre. The matrix is defined as the matrix materials from the reactive powdery polyurethane compositions crosslinked in the composite.

### Support

The fibrous support in the present invention consists of fibrous material (also often referred to as reinforcing fibres). In general any material of which the fibres consist is suitable, however fibrous material of glass, carbon, plastics, such as for example polyamide (aramid) or polyester, natural fibres or mineral fibre materials such as basalt fibres or ceramic fibres (oxide fibres based on aluminium oxides and/or silicon oxides) is preferably used. Mixtures of fibre types, such as for example fabric combinations of aramid- and glass fibres, or carbon and glass fibres, can also be used. Likewise, hybrid composite components can be produced with prepregs from different fibrous supports.

Glass fibres are the most commonly used fibre types mainly owing to their relatively low price. In principle here, all types of glass-based reinforcing fibres are suitable (E glass, S glass, R glass, M glass, C glass, ECR glass, D glass, AR glass, or hollow glass fibres).

Carbon fibres are generally used in high performance composite materials where the lower density with at the same time higher strength compared to glass fibres is also an important factor. Carbon fibres (also carbon fibres) are industrially produced fibres from carbon-containing starting materials which are converted by pyrolysis to carbon in graphite-like configuration.

A distinction is made between isotropic and anisotropic types: isotropic fibres have only low strength values and lower industrial significance, anisotropic fibres exhibit high strength and rigidity values with at the same time low elongation at break.

Here, all textile fibres and fibre materials which are obtained from plant and animal material (e.g. wood, cellulose, cotton, hemp, jute, flax, sisal or bamboo fibres) are described as natural fibres.

Aramid fibres, similarly also to carbon fibres, have a negative coefficient of thermal expansion, i.e. become shorter on heating. Their specific strength and their modulus of elasticity is markedly lower than that of carbon fibres. In combination with the positive coefficient of expansion of the matrix resin, highly dimensionally stable components can be manufactured. Compared to carbon fibre reinforced plastics, the pressure resistance of aramid fibre composite materials is markedly lower. Well-known brand names for aramid fibres are Nomex® and Kevlar® from DuPont, or Teijinconex®, Twaron® and Technora® from Teijin. Supports made of glass fibres, carbon fibres, aramid fibres or ceramic fibres are particularly suitable.

The fibrous material is a planar textile body. Planar textile bodies of non-woven material, likewise so-called knitted goods, such as hosiery and knitted fabrics, but also non-knitted skein such as fabric, non-woven or netting, are suitable. In addition, a distinction is made between long fibre and short fibre materials as supports. Also suitable according to the invention are rovings and yarns. All the said materials are suitable as fibrous supports in the context of the invention.

An overview of reinforcing fibres is contained in “Composites Technologien, Paolo Ermanni (Version 4), Script for Lecture ETH Zürich, August 2007, Chapter 7”.

### Matrix Material

In principle, all powdery reactive polyurethane compositions are suitable as matrix materials. According to the invention, suitable polyurethane compositions consist of mixtures of a polymer b) having functional groups—reactive towards NCO groups—(binder), also referred to as resin, and di- or polyisocyanates temporarily deactivated, in other words internally blocked and/or blocked with blocking agents, also described as curing agent a) (component).

As functional groups of the polymers b) (binder), hydroxyl groups, amino groups and thiol groups which react with the free isocyanate groups by addition and thus crosslink and cure the polyurethane composition are suitable. The binder components must be of solid resin nature (glass temperature greater than room temperature). Possible binders are polyesters, polyethers, polyacrylates, polycarbonates and polyurethanes with an OH number of 20 to 500 mg KOH/gram and an average molecular weight of 250 to 6000 g/mol. Hydroxyl group-containing polyesters or polyacrylates with an OH number of 20 to 150 mg KOH/gram and an average molecular weight of 500 to 6000 g/mol are particularly preferred. Of course mixtures of such polymers can also be used. The quantity of the polymers b) having functional groups is selected such that for each functional group of the component b) 0.3 to 0.7 uretdione group of the component a) are consumed.

As the curing component a), di- and polyisocyanates blocked with blocking agents or internally blocked (uretdione) are suitable.

The di- and polyisocyanate used according to the invention can consist of any aromatic, aliphatic, cycloaliphatic and/or (cyclo)aliphatic di- and/or polyisocyanates.

As aromatic di- or polyisocyanates, in principle all known aromatic compounds are suitable. 1,3- and 1,4-phenylene diisocyanate, 1,5-naphthylene diisocyanate, tolidine diisocyanate, 2,6-toluoylene diisocyanate, 2,4-toluoylene diisocyanate (2,4-TDI), 2,4′-diphenylmethane diisocyanate (2,4′-MDI), 4,4′-diphenylmethane diisocyanate, the mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene are particularly suitable.

Suitable aliphatic di- or polyisocyanates advantageously have 3 to 16 carbon atoms, preferably 4 to 12 carbon atoms, in the linear or branched alkylene residue and suitable cycloaliphatic or (cyclo)aliphatic diisocyanates advantageously have 4 to 18 carbon atoms, preferably 6 to 15 carbon atoms, in the cycloalkylene residue. Those skilled in the art adequately understand (cyclo)aliphatic diisocyanates simultaneously to mean cyclically and aliphatically bound NCO groups, such as is for example the case with isophorone diisocyanate. In contrast to this, cycloaliphatic diisocyanates are understood to mean those which only have NCO groups directly bound to the cycloaliphatic ring, e.g. H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate and dodecane di- and triisocyanate.

Isophorone diisocyanate (IPDI), hexamethylene diisocyanate (HDI), diisocyanato-dicyclohexylmethane (H12MDI), 2-methylpentane diisocyanate (MPDI), 2,2,4-trimethylhexamethylene diisocyanate/2,4,4-trimethylhexamethylene diisocyanate (TMDI), and norbornane diisocyanate (NBDI) are preferred. IPDI, HDI, TMD1 and H12MDI are quite particularly preferably used, the isocyanurates also being usable.

Also suitable are 4-methyl-cyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenebis(cyclohexyl) diisocyanate and 1,4-diisocyanato-4-methyl-pentane.

Of course, mixtures of the di- and polyisocyanates can also be used.

Furthermore, oligo- or polyisocyanate which can be produced from the said di- or polyisocyanates or mixtures thereof by linkage by means of urethane, allophanate, urea, biuret, uretdione, amide, isocyanurate, carbodiimide, uretonimine, oxadiazinetrione or iminooxadiazinedione structures are preferably used. Isocyanurate, in particular from IPDI and HDI, are particularly suitable.

The polyisocyanates used according to the invention are blocked. Possible for this are external blocking agents such as for example ethyl acetoacetate, diisopropylamine, methyl ethyl ketoxime, diethyl malonate, ε-caprolactam, 1,2,4-triazole, phenol or substituted phenols and 3,5-dimethylpyrazole.

The curing components preferably used are IPDI adducts which contain isocyanurate groupings and ε-caprolactam blocked isocyanate structures.

Internal blocking is also possible and this is preferably used. The internal blocking is effected via dimer formation via uretdione structures which at elevated temperature again cleave back into the isocyanate structures originally present and hence set the crosslinking with the binder in motion.

Optionally, the reactive powdery polyurethane compositions can contain additional catalysts. These are organometallic catalysts, such as for example dibutyltin dilaurate, tin octoate, bismuth neodecanoate, or else tertiary amines, such as for example 1,4-diazabicyclo[2.2.2]-octane, in quantities of 0.001-1 wt. %.

For the production of the reactive powdery polyurethane compositions, the additives usual in powder technology, such as levelling agents, e.g. polysilicones or acrylates, light screening agents, e.g. sterically hindered amines, or other auxiliary substances such as were for example described in EP 669 353, can be added in a total quantity of 0.05 to 5 wt. %. Fillers and pigments such as for example titanium dioxide can be added in a quantity up to 30 wt. % of the total composition.

In the context of this invention reactive means that the polyurethane compositions used according to the invention cure at temperatures from 160° C., this depending on the nature of the support.

The reactive powdery polyurethane compositions used according to the invention are cured under normal conditions, e.g. with DBTL catalysis, from 160° C., usually from ca. 180° C. The time for the curing of the polyurethane composition used according to the invention is as a rule within 5 to 60 minutes.

A preferred subject matter of the present invention is prepregs with a matrix material from a reactive powdery polyurethane composition containing uretdione groups and in essence containing

a) at least one curing agent containing uretdione groups, based on polyaddition compounds from polyisocyanates containing aliphatic, (cyclo)aliphatic or cycloaliphatic uretdione groups and hydroxyl group-containing compounds, where the curing agent exists in solid form below 40° C. and in liquid form above 125° C. and has a free NCO content of less than 5 wt. % and a uretdione content of 3-25 wt. %,
b) at least one hydroxyl group-containing polymer which exists in solid form below 40° C. and in liquid form above 125° C. and has an OH number between 20 and 200 mg KOH/gram,
c) optionally at least one catalyst,
d) optionally auxiliary agents and additives known from polyurethane chemistry,
so that the two components a) and b) are present in the ratio that for every hydroxyl group of the component b) 0.3 to 0.7 uretdione group of the component a) is consumed, preferably 0.45 to 0.55. The latter corresponds to an NCO/OH ratio of 0.9 to 1.1 to 1.

Polyisocyanates containing uretdione groups are well known and are for example described in U.S. Pat. No. 4,476,054, U.S. Pat. No. 4,912,210, U.S. Pat. No. 4,929,724 and EP 417 603. A comprehensive overview of industrially relevant processes for the dimerization of isocyanates to uretdiones is provided by J. Prakt. Chem. 336 (1994) 185-200. In general, the conversion of isocyanates to uretdiones is effected in the presence of soluble dimerization catalysts such as for example dialkylaminopyridines, trialkylphosphines, phosphorous acid triamides or imidazoles. The reaction—optionally performed in solvents, but preferably in the absence of solvents—is stopped by addition of catalyst poisons on attainment of a desired conversion level. Excess monomeric isocyanate is then removed by flash evaporation. If the catalyst is sufficiently volatile, the reaction mixture can be freed from catalyst in the course of the monomer separation. The addition of catalyst poisons can in this case be omitted. Essentially, a broad palette of isocyanates is suitable for the production of polyisocyanates containing uretdione groups. The aforesaid di- and polyisocyanate can be used. However dl- and polyisocyanates from any aliphatic, cycloaliphatic and/or (cyclo)allphatic di- and/or polyisocyanates are preferred. According to the invention, isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI) or norbornane diisocyanate (NBDI) are used. Quite especially preferably, IPDI, HDI, TMDI and H₁₂MDI are used, and the isocyanurates can also be used.

Quite especially preferably, IPDI and HDI are used for the matrix material.

The conversion of these polyisocyanates containing uretdione groups to curing agents a) containing uretdione groups comprises the reaction of the free NCO groups with hydroxyl group-containing monomers or polymers, such as for example polyesters, polythioethers, polyethers, polycaprolactams, polyepoxides, polyester amides, polyurethanes or lower molecular weight di, tri- and/or tetrahydric alcohols as chain extenders and optionally monoamines and/or monohydric alcohols as chain terminators and has already often been described (EP 669 353, EP 669 354, DE 30 30 572, EP 639 598 or EP 803 524). Preferred curing agents a) having uretdione groups have a free NCO content of less than 5 wt. % and a content of uretdione groups of 3 to 25 wt. %, preferably 6 to 18 wt. % (calculated as C₂N₂O₂, molecular weight 84). Polyesters and monomeric dihydric alcohols are preferred. Apart from the uretdione groups the curing agents can also exhibit isocyanurate, biuret, allophanate, urethane and/or urea structures.

In the case of the hydroxyl group-containing polymers b), polyesters, polyethers, polyacrylates, polyurethanes and/or polycarbonates with an OH number of 20-200 in mg KOH/gram are preferably used. Particularly preferably, polyesters with an OH number of 30-150, an average molecular weight of 500-6000 g/mol which exist in solid form below 40° C. and in liquid form above 125° C. are used. Such binders have for example been described in EP 669 354 and EP 254 152. Of course, mixtures of such polymers can also be used. The quantity of the hydroxyl group-containing polymers b) is selected such that for every hydroxyl group of the component b) 0.3 to 0.7 uretdione group of the component a), preferably 0.45 to 0.55, is consumed.

Optionally, additional catalysts c) can also be contained in reactive powdery polyurethane compositions. These are organometallic catalysts, such as for example dibutyl tin dilaurate, zinc octoate, bismuth neodecanoate, or else tertiary amines, such as for example 1,4-diazabicyclo[2.2.2]octane, in quantities of 0.001-1 wt. %.

For the production of the reactive powdery polyurethane compositions, the additives d) usual in coating powder technology, such as levelling agents, e.g. polysilicones or acrylates, light screening agents, e.g. sterically hindered amines, or other additives such as were for example described in EP 669 353, can be added in a total quantity of 0.05 to 5 wt. %. Fillers and pigments such as for example titanium dioxide can be added in a quantity up to 30 wt. % of the total composition.

The reactive powdery polyurethane compositions used according to the invention are cured under normal conditions, e.g. with DBTL catalysis, from 160° C., usually from ca. 180° C.

The reactive polyurethane compositions used according to the invention provide very good flow and hence good impregnation behaviour and in the cured state excellent chemicals resistance. In addition, with the use of aliphatic crosslinking agents (e.g. IPDI or H₁₂MDI) good weather resistance is also achieved.

The reactive powdery polyurethane compositions used according to the invention as matrix material are solid, powdery and non-sticky at room temperature. They essentially consist of a mixture of a reactive resin and a curing agent. This mixture has a Tg of at least 40° C. and as a rule reacts only above 160° C., to give a crosslinked polyurethane and thus forms the matrix of the composite. This means that the prepregs according to the invention after their production are made up of the support and the applied reactive powdery polyurethane composition as matrix material, which is present in noncrosslinked but reactive form. The prepregs are thus storage-stable, as a rule for several days and even weeks and can thus at any time be further processed into composites. This is the essential difference from the 2-component systems already described above, which are reactive and not storage-stable, since after application these immediately react and crosslink to give polyurethanes.

The homogenization of all components for the production of the polyurethane composition for the production of the prepregs can be effected in suitable units, such as for example heatable stirred kettles, kneaders or even extruders, during which upper temperature limits of 120 to 130° C. should not be exceeded. The mixing of the individual components is preferably effected in an extruder at temperatures which lie above the melting ranges of the individual components, but below the temperature at which the crosslinking reaction starts. The solidified compositions formed are ground and may, for example, be divided into different fractions by screening (for example, particle diameter <63 μm, 63-100 μm, >100 μm).

Also subject matter of the invention is the use of the reactive powdery polyurethane composition B) according to the invention, for the production of prepregs, in particular with fibrous supports (fibre reinforcement) of glass, carbon or aramid fibres and the composites produced therefrom.

The prepregs can in principle be produced by any desired processes, preferably by powder impregnation. In the suitable method here, the reactive powdery polyurethane composition is applied to the support by a scattering process. Other possibilities are a fluidized-bed sintering process, pultrusion, and a spray process.

In the case of powder impregnation, the matrix material—normally thermoplastic polymer—is present in powder form. In order to minimize flow paths for the highly viscous melt of thermoplastic matrix systems for wetting and encapsulating the fibres, the usual method in the prior art is to disperse the thermoplastic powder in a stream of air in the fluidized-bed process and to use the air stream to spread the filaments of yarn. The individual powder particles can thus reach the individual fibres. The adhesion of the powder can be additionally improved by electrostatic charging of the powder. After passage through the fluidized bed, the filaments of yarn, with the lightly adhering powder, are passed through a heating section in which incipient melting of the matrix polymer powder takes place. A consolidation step is then required in the production of the composite components to complete the wetting of the filaments.

In the case of the use according to the invention of the reactive powdery polyurethane composition according to the invention, processes of this type for flow-path shortening are not essential, since the melt of the prepolymers (uncrosslinked powder coating melt) has a low viscosity suitable for permitting the wetting of the fibres, and this represents a considerable advantage of the prepregs according to the invention in comparison with the prior art.

The powder (all or one fraction) is preferably applied by way of scattering processes to the fibrous support, e.g. to webs made of glass nonwoven/fabric, of carbon nonwoven/fabric, or of aramid nonwoven/fabric, and then fixed. In order to avoid powder losses, it is preferable that the fibrous support treated with powder is heated directly after the scattering procedure in a heating section (e.g. using IR sources), so that incipient sintering of the particles takes place, but temperatures of from 80 to 100° C. should not be exceeded here, in order to inhibit incipient reaction of the reactive matrix material. These prepregs can, if necessary, be cut to shape and combined to give various formats.

The invention provides a process for producing prepregs by application of component B), preferably by scattering processes, to component A), and optional fixing of B), preferably by exposure to heat, particularly preferably by incipient sintering.

In order to consolidate the prepreg sublayers to give a single composite (component), and in order to crosslink the matrix material according to the invention to give the matrix, the prepregs are cut to size, and optionally fixed by sewing or other means, and pressed in a suitable mould under pressure and optionally with application of vacuum. For the purposes of this invention, this procedure for producing the composites from the prepregs according to the invention takes place at temperatures above about 160° C., varying with the hardening time.

The invention also provides the use of the prepregs, in essence composed of

A) at least one fibrous support and
B) at least one reactive powdery polyurethane composition as matrix material for the production of composites in boat and shipbuilding, in aerospace technology, in automobile manufacture, and for bicycles, preferably motorcycles and cycles, and in the sectors automotive, construction, medical engineering, sport, electrical and electronics industry, and power generating plants, e.g. for rotor blades in wind power plants.

Also subject matter of the invention are the composite components produced from the prepregs according to the invention, composed of
A) at least one fibrous support and
B) at least one crosslinked polyurethane composition, preferably polyurethane composition containing uretdione groups, as matrix.

The invention also provides a process for producing composite components, where a prepreg composed of
A) at least one fibrous support and
B) at least one reactive powdery polyurethane composition, preferably polyurethane composition containing uretdione groups, as matrix material; is produced at temperatures above 160° C., preferably 180° C., optionally with use of pressure and/or vacuum.

Below, the invention is illustrated by examples.

### EXAMPLES

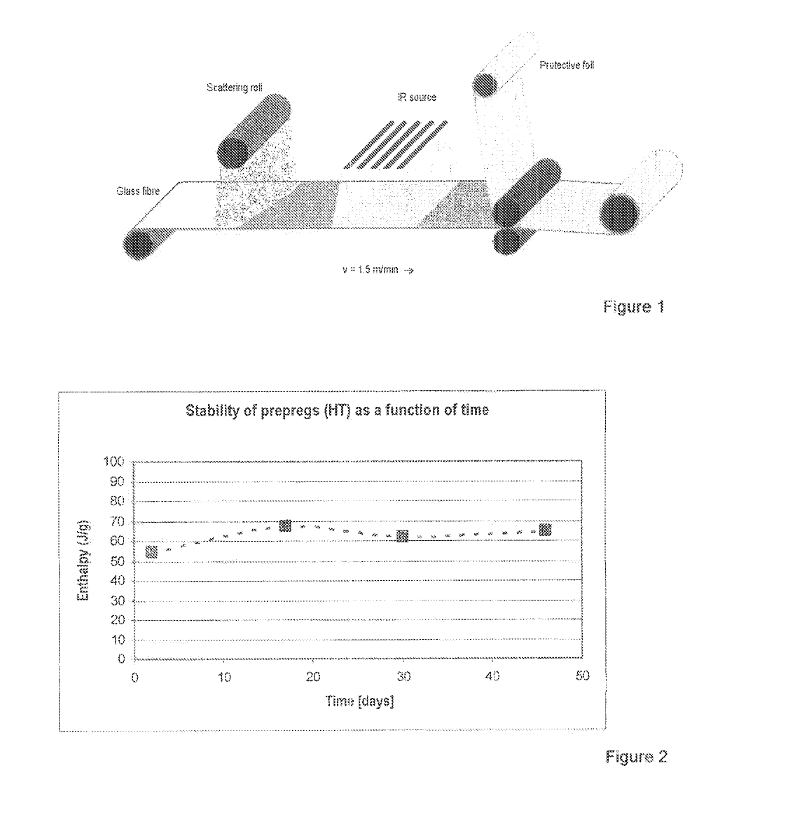

### Depiction of Laboratory Scattering Equipment Used (Villars Minicoater 200) FIG. 1

### Glass Fibre Nonwovens/Fabrics Used:

The following glass fibre nonwovens/fabrics were used in the examples and are referred to below as type I and type II.

Type I is a linen E glass fabric 281 L Art. No. 3103 from “Schlösser & Cramer”. The fabric has an areal weight of 280 g/m².

Type II GBX 600 Art. No. 1023 is a sewn biaxial E glass nonwoven (−45/+45) from “Schlösser & Cramer”. This should be understood to mean two layers of fibre bundles which lie one over the other and are set at an angle of 90 degrees to one another. This structure is held together by other fibres, which do not however consist of glass. The surface of the glass fibres is treated with a standard size which is aminosilane-modified. The nonwoven has an areal weight of 600 g/m².

### DSC Measurements

The DSC tests (glass transition temperature determinations and enthalpy of reaction measurements) were performed with a Mettler Toledo DSC 821e as per DIN 53765.

### Reactive Powdery Polyurethane Composition

A reactive powdery polyurethane composition with the following formula was used for the production of the prepregs and the composites.

(Data in % by weight)

| | Formulation HT |
|---|---|
| | (according to |
| Example | the invention) |
| VESTAGON BF 9030 (uretdione | 26.81 |
| group-component a)), Evonik Degussa | |
| FINEPLUS PE 8078 VKRK20 (OH— | 72.69 |
| functional polyester resin component | |
| b)), DIC Co. | |
| BYK 361N | 0.5 |
| NCO:OH ratio | 1:1 |

The milled ingredients from the table are intimately mixed in a premixer and then homogenized in the extruder up to a maximum of 130° C. After cooling, the extrudate is broken and milled in a pinned-disk mill. The average particle diameters of the sieve fractions used were from 63 to 100 μm.

Physical properties

| | HT powder |
|---|---|
| T_{g} [° C.] | about 53 |
| Melting range [° C.] | about 94 |
| Hardening temperature [° C.] | 170-180 |
| Elongation at break of hardened | 8 |
| polyurethane matrix [%] | |
| Modulus of elasticity of hardened | about 870 |
| polyurethane matrix [MPa] | |
| Volume shrinkage through crosslinking | <0.2% |
| Viscosity minimum of uncrosslinked melt | 158° C./30 Pa · s |

Selection of suitable sinter conditions during various preliminary experiments showed that the following settings have good suitability for producing the prepregs on a minicoater:

About 150 g/powder were applied to one square metre of glass fibre nonwoven, using a web speed of about 1.2 m/min. This corresponds to a layer thickness of about 500 μm with a standard deviation of about 45 μm.

Using a power level of 560 W for the IR source, prepregs could be produced by this method at temperatures of from 75 to 82° C., by incipient sintering of the reactive powdery polyurethane composition, and it was of no significance here whether the incipient sintering of the powders was carried out while the structure of the powder remained discernible or whether a complete melt was produced on the glass fibre nonwoven, as long as the reactivity of the powdery polyurethane composition was retained.

### Storage Stability of the Prepregs

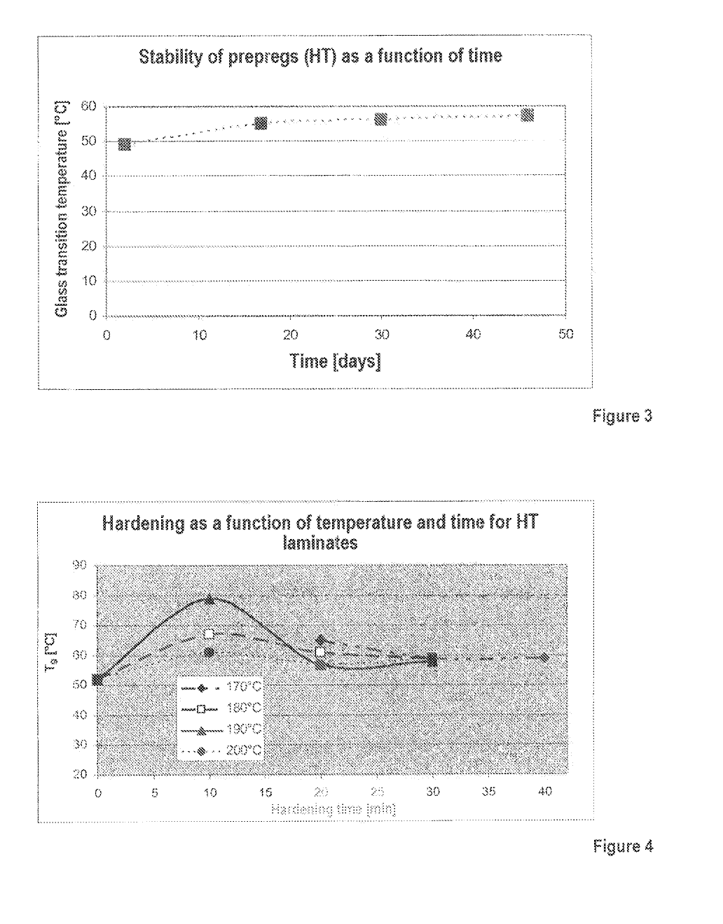

The storage stability of the prepregs was determined from the enthalpies of reaction of the crosslinking reaction by means of DSC studies. The results are shown in FIG. 2 and FIG. 3.

The crosslinking capacity of the PU prepregs is not impaired by storage at room temperature for a period of at least 7 weeks.

### Composite Component Production

The composite components were produced on a composite press by a compression technique known to those skilled in the art. The homogeneous prepregs produced on the scattering apparatus were compressed into composite materials on a benchtop press. This benchtop press is the Polystat 200 T from the firm Schwabenthan, with which the prepregs were compressed to the corresponding composite sheets at temperatures between 120 and 200° C. The pressure was varied between normal pressure and 450 bar. Dynamic compression, i.e. alternating applications of pressure, can prove advantageous for the crosslinking of the fibres depending on the component size, thickness and polyurethane composition and hence the viscosity setting at the processing temperature.

In one example, the temperature of the press was increased from 90° C. during the melting phase to 110° C., the pressure was increased to 440 bar after a melting phase of 3 minutes and then dynamically varied (7 times each of 1 minute duration) between 150 and 440 bar, during which the temperature was continuously increased to 140° C. Next the temperature was raised to 170° C. and at the same time the pressure was held at 350 bar until the removal of the composite component from the press after 30 minutes height.

The resultant hard, rigid, chemicals resistant and impact resistant composite components (sheet products) with a fibre volume content of >50% were tested for the degree of curing (determination by DSC). The determination of the glass transition temperature of the cured matrix indicates the progress of the crosslinking at different curing temperatures. With the polyurethane composition used, the crosslinking is complete after ca. 25 minutes, and then an enthalpy of reaction for the crosslinking reaction is also no longer detectable. The results are shown in FIG. 4.

Two composite materials were produced under exactly identical conditions and their properties then determined and compared. This good reproducibility of the properties could also be confirmed in the determination of the interlaminar shear strength (ILSS). Here an averaged ILSS of ca. 40 N/mm² was attained.

1. A prepregs comprising
A) at least one fibrous support and
B) at least one reactive powdery polyurethane composition as matrix material.

2. The prepreg according to claim 1, wherein the matrix material has a Tg of at least 40° C.

3. The prepregs according to claim 1,
wherein the fibrous support is a fibrous material of glass, carbon, plastics such as polyamide (aramid) or polyester, a natural fibre or a mineral fibre such as a basalt fibre or a ceramic fibre.

4. The prepregs according to claim 1,
wherein the fibrous support is a planar textile body of non-woven material, a knitted good, a non-knitted skein.

5. The prepregs according to claim 1,
wherein the powdery polyurethane composition consists essentially of, as binders, mixtures made of a polymer b) which has functional groups reactive towards isocyanates, and, as curing agent a), isocyanate which has been internally blocked and/or has been blocked with blocking agents.

6. The prepregs according to claim 5,
wherein the polymer has at least one group selected from the group consisting of a hydroxyl group, an amino group and a thiol group.

7. The prepregs according to claim 5,
wherein the isocyanate is selected from the group consisting of:
an isophorone diisocyanate (IPDI),
hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethyl-hexamethylene diisocyanate (TMDI) norbornane diisocyanate (NBDI), and isocyanurates thereof.

8. The prepregs according to claim 1,
further comprising an external blocking agent selected from the group consisting of ethyl acetoacetate, diisopropylamine, methyl ethyl ketoxime, diethyl malonate, ε-caprolactam, 1,2,4-triazole, phenol or substituted phenols and 3,5-dimethylpyrazole.

9. The prepregs according to claim 5,
wherein the isocyanate is an IPDI adduct, comprising an isocyanurate grouping and an ε-caprolactam blocked isocyanate structure.

10. The prepregs according to claim 1,
wherein the reactive powdery polyurethane composition B) comprises an additional catalyst, selected from the group consisting of dibutyltin dilaurate, zinc octoate, bismuth neodecanoate, and a tertiary amines in an amount of from 0.001-1 wt. %.

11. The prepregs according to claim 1, wherein the matrix material of one reactive polyurethane composition B) comprises a powdery uretdione group, wherein said powdery uretdione group comprises
a) at least one curing agent containing uretdione groups, based on polyaddition compounds from aliphatic, (cyclo)aliphatic or cycloaliphatic polyisocyanates containing uretdione groups and hydroxyl group-containing compounds, where the curing agent exists in solid form below 40° C. and in liquid form above 125° C., and has a free NCO content of less than 5 wt. % and a uretdione content of 3-25 wt. %,
b) at least one hydroxyl group-containing polymer, which exists in solid form below 40° C. and in liquid form above 125° C. and has an OH number between 20 and 200 mg KOH/gram,
c) optionally at least one catalyst,
d) optionally auxiliary substances and additives known from polyurethane chemistry,
wherein the two components a) and b) are present in the ratio such that for every hydroxyl group of the component b) 0.3 to 0.7 uretdione group of the component a) is consumed.

12. (canceled)

13. A process for producing a prepreg according to claim 1, comprising applying, component B) to component A), and optionally fixing B).

14. (canceled)

15. A composite component, comprising
A) at least one fibrous support and
B) at least one crosslinked polyurethane composition as matrix.

16. A process for producing a composite component, where a prepreg,
comprising
A) at least one fibrous support and
B) at least one reactive powdery polyurethane composition, as matrix material
is produced at temperatures above 160° C., optionally with use of pressure and/or vacuum.

17. The prepreg of claim 5, wherein the polymer is a polyether, a polyacrylate, a polycarbonate or a polyurethane with an OH number of 20 to 500 mg KOH/gram and an average molecular weight of 250 to 600 g/mol.
